(19) United States
(12) Patent Application Publication
(10) Pub. No.: US 2019/0023028 A1
(43) Pub. Date: Jan. 24, 2019

(54) LABEL PRINTER

(71) Applicant: TOSHIBA TEC KABUSHIKI KAISHA, Tokyo (JP)

(72) Inventor: Takesi KAWAGUTI, Mishima Shizuoka (JP)

(21) Appl. No.: 16/042,121

(22) Filed: Jul. 23, 2018

(30) Foreign Application Priority Data
Jul. 24, 2017 (JP) 2017-142870

(51) Int. Cl. B41J 3/407; G06K 15/02; G06K 15/00; H04N 1/031

(52) U.S. Cl. CPC B41J 3/4075; G06K 15/1868; H04N 1/031; G06K 15/408; G06K 15/1843

(57) ABSTRACT

A label printer includes a printing engine configured to print a label image on label papers according to a designated label format as the label papers are conveyed thereto one-by-one, a sensor configured to detect a presence of the label papers in a conveyance path of the label papers, and a controller configured to determine a size of a label paper conveyed to the printing engine based on detection signals of the sensor and detect whether or not there is a mismatch of the size with a size of the designated label format.

### CROSS-REFERENCE TO RELATED APPLICATION

This application is based upon and claims the benefit of priority from Japanese Patent Application No. 2017-142870, filed Jul. 24, 2017, the entire contents of which are incorporated herein by reference.

### FIELD

Embodiments described herein relate generally to a label printer.

### BACKGROUND

A label printer can store a plurality of formats of images to be printed (hereinafter referred to as “label format”), and has a function of printing on a label paper an image generated by combining a commodity name, a date of expiration date, and the like into a label format designated by an operator.

In addition, as the label paper, a plurality of types having different sizes are used. The plurality of types of label papers are adhered to elongated mounts having the same width as each other, the width being measured in a direction orthogonal to the direction along which the label papers are arranged side by side, and the widths of the label papers are substantially the same as each other. The plurality of types of label papers have different heights from each other, the heights being measured in the direction along which the label papers are arranged.

The operator designates a label format and instructs a start of printing after loading a label paper compatible with a size of the designated label format. As a result, the label printer continuously performs printing on a designated number of the designated label papers as one job.

Therefore, in the label printer, when the operator mistakenly loads a label paper of a size incompatible with the size of the designated label format, the designated label format may be erroneously printed on a label of the wrong size for the entire job. As a result, there is a possibility that waste of label paper occurs.

For example, when a label paper of a size smaller than the size of the designated label format is loaded, only a portion of the image to be printed is printed on the label paper, and a remaining portion of the image is not printed. Label papers printed in such a wrong manner are not usable in general.

Under these circumstances, it is desired to minimize the waste of label paper as much as possible.

### DESCRIPTION OF THE DRAWINGS

FIG. 1 is a block diagram illustrating a main circuit configuration of a label printer according to one embodiment.

FIG. 2 is a diagram illustrating a portion of a structure of a print engine in FIG. 1.

FIG. 3 is a diagram schematically illustrating a configuration of a data record included in a management table.

FIG. 4 is a flowchart illustrating a procedure of information processing by a controller in FIG. 1.

FIG. 5 illustrates a first example of a form confirmation screen.

FIG. 6 illustrates a second example of a form confirmation screen.

FIG. 7 is a diagram illustrating a level change of a detection signal at a label sensor in FIG. 2.

### DETAILED DESCRIPTION

Embodiments provide a label printer capable of minimizing waste of a label paper.

In general, according to one embodiment, a label printer includes a printing engine configured to print a label image on label papers according to a designated label format as the label papers are conveyed thereto one-by-one, a sensor configured to detect a presence of the label papers in a conveyance path of the label papers, and a controller configured to determine a size of a label paper conveyed to the printing engine based on detection signals of the sensor and detect whether or not there is a mismatch of the size with a size of the designated label format.

Hereinafter, an example of an embodiment will be described with reference to the drawings.

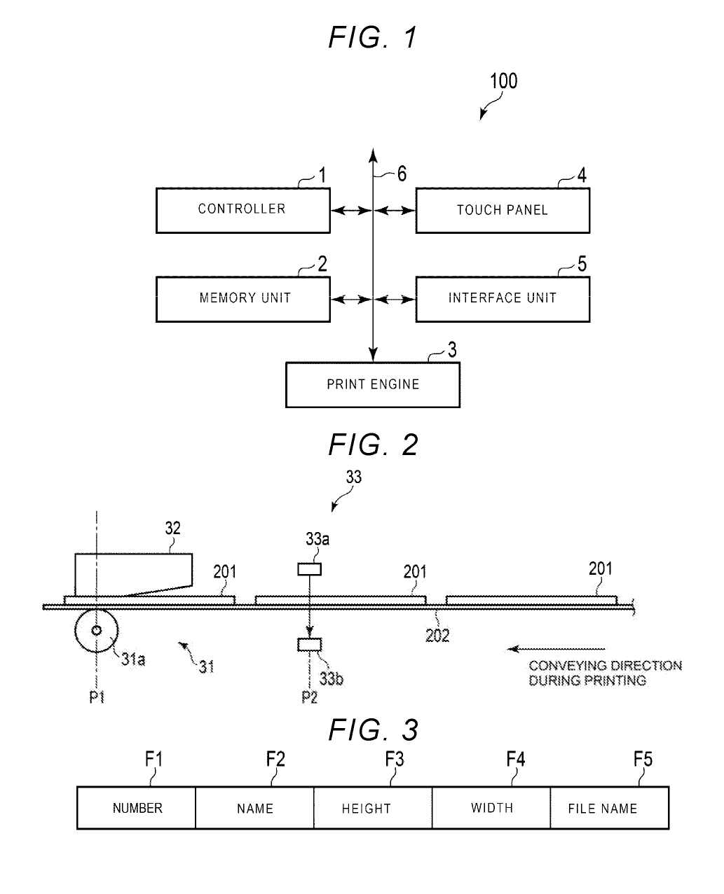

FIG. 1 is a block diagram illustrating a main circuit configuration of a label printer 100.

The label printer 100 is provided with a controller 1, a memory unit 2, a print engine 3, a touch panel 4, an interface unit 5, and a transmission system 6. The controller 1, the memory unit 2, the print engine 3, the touch panel 4, and the interface unit 5 are each connected to the transmission system 6. The transmission system 6 allows data and signals to be exchanged between the connected parts. As the transmission system 6, a well-known transmission system including various buses such as a system bus and various interface circuits connecting these buses and respective parts can be used.

The controller 1 controls each part to realize various functions of the label printer 100. The controller 1 includes, for example, a computer provided with a processor and a memory. In this case, the controller 1 realizes control of each part by the above computer performing information processing using an operating system, a middleware and an application program. A portion of the control function of the controller 1 may be realized by using a field-programmable gate array (FPGA), an application specific integrated circuit (ASIC), or the like.

The memory unit 2 stores various types of data necessary for an operation of the label printer 100, such as data in a label format.

The print engine 3 prints an image on a label paper. The print engine 3 includes, for example, a conveying mechanism, a print head and a print controller. The print engine 3 is an example of a printing unit.

FIG. 2 is a diagram illustrating a portion of a structure of the print engine 3.

The conveying mechanism 31 includes a platen roller 31a and the like, and conveys a mount 202, to which the label paper 201 is adhered, in an arrangement direction of the label paper 201.

The print head 32 is disposed so as to nip the label paper 201 and the mount 202 conveyed by the conveying mechanism 31 between the platen roller 31a and the print head 32. The print head 32 prints an image on the label paper 201 pressed against the print head 32 by the platen roller 31a. As the print head 32, a well-known print head such as a thermal head can be used, for example.

The print controller controls the conveying mechanism 31 and the print head 32 so that an image is formed at an appropriate position on the label paper 201.

The print engine 3 also includes a label sensor 33. The label sensor 33 is provided at a detection position P2 on an upstream side of a printing position P1 of the print head 32 in the conveying direction of the label paper 201. The label sensor 33 is, for example, a transmission type optical sensor provided with a light emitting portion 33a and a light receiving portion 33bon either side of the conveying path of the label paper 201 such that the optical path from the light emitting portion 33a to the light receiving portion 33b can be blocked by the label paper 201 conveyed by the conveying mechanism. 31.

The touch panel 4 illustrated in FIG. 1 displays a screen under the control of the controller 1. The screen to be displayed on the touch panel 4 is, for example, a screen for notifying an operator of the operation state of the label printer and a graphical user interface (GUI) screen for receiving an instruction from the operator, and the like. The touch panel 4 detects a touch operation by the operator.

The interface unit 5 is an interface circuit that provides an interface for exchanging data with external devices. The interface unit 5 may include one or a plurality of devices interfacing with each of storage media such as, for example, a communication network such as a local area network (LAN), a communication path such as a universal serial bus (USB), or a memory card.

Additionally, a management table for managing the label format is stored in the memory unit 2, in addition to the label format data. The management table is a collection of data records associated with each of label formats.

FIG. 3 is a diagram schematically illustrating a configuration of the data record included in the management table.

The data record of the management table includes fields F1, F2, F3, F4, and F5. The data record may include fields other than these fields F1 to F5.

The data in the field F1 indicates a number for identifying the corresponding label format. The data in the field F2 indicates a name for identifying the corresponding label format. The data in the field F3 indicates a height of the corresponding label format. The data in the field F4 indicates a width of the corresponding label format. The data in the field F5 indicates a file name of the data in the label format.

Next, the operation of the label printer 100 configured as described above will be described.

The label printer 100 can use data of a label format received from another information processing apparatus at the time of printing. As an example, in a personal computer on which an application program for creating a label format is activated, a label format is created under an operation of a creator of the label format. The label printer 100 acquires data in the label format via the communication network or the communication path, from a storage medium through the interface unit 5, or from the memory unit 2. At this time, data representing the name, the height, and the width designated by the creator on the above personal computer is provided with the data in the label format. Therefore, the controller 1 adds a new data record for managing the label format to the management table stored in the memory unit 2. At this time, the controller 1 assigns a number different from the number for identifying the label format previously stored in the memory unit 2, and stores the data representing this number and the data of the provided name, height, and width in the fields F1 to F4, respectively. In addition, the controller 1 stores the file name for managing the data in the label format in the memory unit 2 in the field F5 of the above data record.

When a predetermined operation for label printing is detected on the touch panel 4, the controller 1 executes the following information processing according to a firmware or the application program. The contents of the processing to be described below are merely an example, and various processing capable of obtaining similar results can be appropriately used.

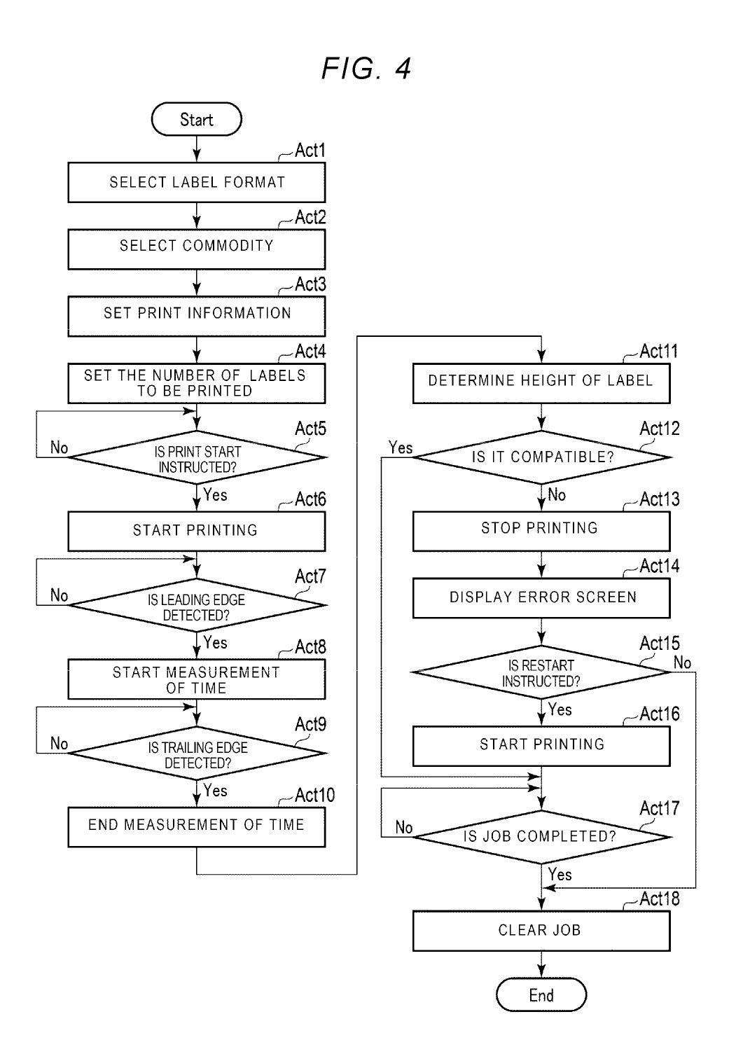

FIG. 4 is a flowchart illustrating a procedure of information processing by the controller 1.

In Act 1, the controller 1 selects one of the label formats according to the operation by the operator. For example, the controller 1 causes the touch panel 4 to display a form confirmation screen.

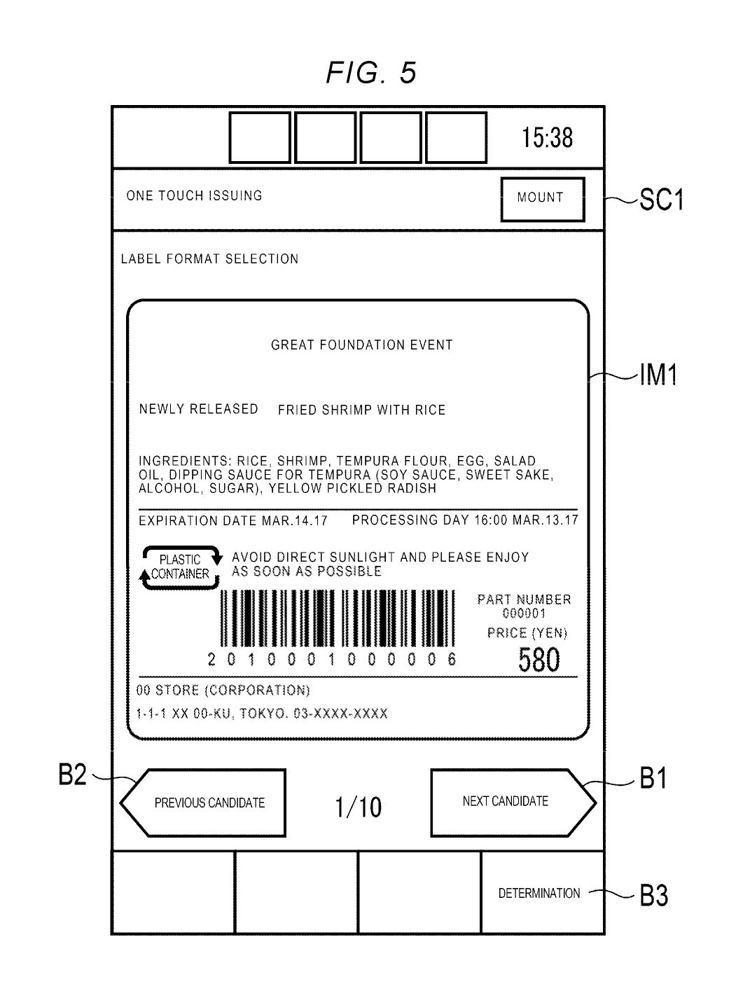

FIG. 5 illustrates a form confirmation screen SC1 as an example.

The form confirmation screen SC1 includes a preview image IM1 of the data identified by the file name indicated in the field F5 of the data record in which the smallest number in the management table is stored in the field F1. In addition, the form confirmation screen SC1 includes the buttons B1, B2, and B3.

The operator touches the button B1 or B2 if the preview image IM1 is not a desired label format and wishes to confirm another label format. When the touch panel 4 detects that the button B1 is touched, the controller 1 determines the next smallest number to the number of the label format being displayed as the preview image. When the touch panel 4 detects that the button B2 is touched, the controller 1 determines the largest number among the numbers smaller than the number of the label format being displayed as the preview image. The controller 1 acquires the data record in which the determined number is stored in the field F1. The controller 1 causes the touch panel 4 to display a form confirmation screen including a preview image of data identified by the file name indicated in the field F5 of the data record.

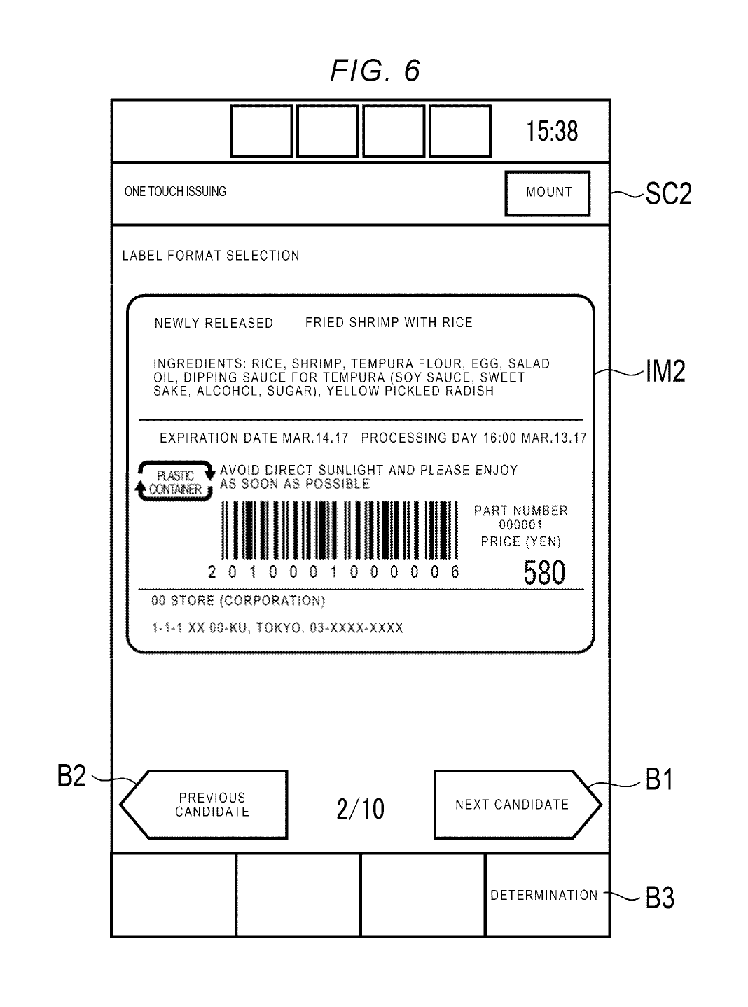

FIG. 6 illustrates a form confirmation screen SC2 as an example.

The form confirmation screen SC2 is an example of a form confirmation screen displayed in response to the touch of the button B1 by the operator as described above.

The form confirmation screen SC2 includes the preview image IM2 of the identified data. In addition, the form confirmation screen SC2 includes the buttons B1, B2, and B3 in the same manner as the form screen SC1.

As is clear from the comparison between the preview image IM1 illustrated in FIG. 5 and the preview image IM2 illustrated in FIG. 6, the two label formats have different heights.

To use the label format displayed as the preview image, the operator touches the button B3. When the touch panel 4 detects that the button B3 is touched, the controller 1 selects the corresponding label format.

In Act 2, the controller 1 selects a commodity to represent a commodity name on a label. For example, the controller 1 causes the touch panel 4 to display a screen representing a list of commodities registered in advance. In response to the touch panel 4 detecting that the operator touches the commodity represented on the screen, the controller 1 selects the commodity as a commodity to represent the commodity name to be printed on the label.

In Act 3, the controller 1 sets print information according to an operation by the operator. The print information is information that may change such as price and expiration date among information expressed in labels. What kind of information is set as the print information differs depending on the label format. In FIGS. 5 and 6, as preview images IM1 and IM2, information corresponding to the print information to be set here and an image indicating the commodity name, are illustrated. This is because the controller 1 generates a preview image including information predetermined for preview. In the preview image, an image in which the commodity name and print information are blank may be used.

In Act 4, the controller 1 sets the number of labels to be printed according to the operation by the operator. For example, the controller 1 causes the touch panel 4 to display a screen including a ten key, and sets the number of papers to be printed according to the number manipulation on this screen.

In Act 5, the controller 1 waits for a print start instruction. For example, the controller 1 causes the touch panel 4 to display a screen for allowing the operator to confirm the label format and the commodity selected so far, the content of the set print information, and the number of labels to be printed. The controller 1 causes the touch panel 4 to display a button on the screen for allowing the operator to instruct to start printing. The controller 1 waits until the button is touched. The controller 1 may accept an instruction to redo all or a portion of Act 1 to Act 4 and may redo all or a portion of Act 1 to Act 4 in response to the instruction. When the touch panel 4 detects that the operator touches the button for instructing to start printing, the controller 1 makes a determination of Yes and proceeds to Act 6.

In Act 6, the controller 1 requests the print engine 3 to start printing according to the instruction for printing. Specifically, the controller 1 generates a print image including the commodity name of the selected commodity and the set print information in the label format selected as described above. The controller 1 sends image data representing the print image to the print engine 3 with notification of the number of papers to be printed. In response to the request, the print engine 3 operates to sequentially print the print image on the label paper 201. The operation of the print engine 3 at this time may be the same as the operation performed by the existing label printer. The print engine 3 controls the timing of printing so that the print image is printed at an appropriate position on the label paper 201 based on the detection result of the label sensor 33.

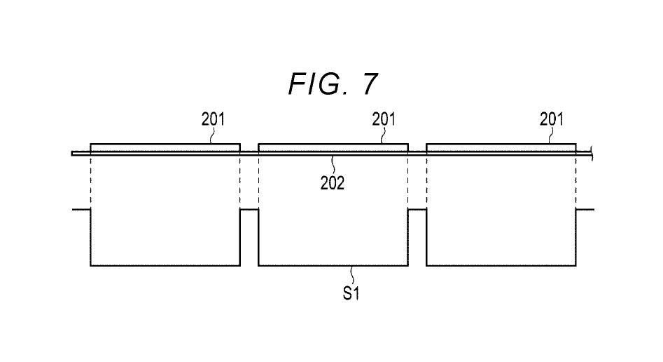

FIG. 7 is a diagram illustrating a level change of a detection signal at the label sensor 33.

In the label sensor 33, when the label paper 201 is not positioned and only the mount 202 is positioned on the optical path from the light emitting portion 33a to the light receiving portion 33b, the light emitted from the light emitting portion 33a is transmitted through the mount 202, such that most of the light emitted from the light emitting portion 33a reaches the light receiving portion 33b. In addition, when the label paper 201 is positioned on the optical path, the light emitted from the light emitting portion 33a is mostly blocked and attenuated by the label paper 201, and the light amount reaching the light receiving portion 33b is smaller than a case where the label paper 201 is not positioned on the optical path. As a result, the detection signal S1 at the label sensor 33 becomes a signal illustrating the level change as illustrated in FIG. 7.

That is, the level of the detection signal S1 significantly decreases at the time when a leading edge of the label paper 201 reaches the detection position P2, and the level of the detection signal S1 significantly increases at the time when a trailing edge of the label paper 201 reaches the detection position P2.

In Act 7, the controller 1 waits until the leading edge of the label paper 201 is detected by the label sensor 33. Specifically, the controller 1 monitors the level of the detection signal S1 at the label sensor 33. When the level of the detection signal S1 falls below a predetermined threshold, the controller 1 determines that the leading edge of the label paper 201 is detected by the label sensor 33, that is, Yes. In this case, the controller 1 proceeds to Act 8.

In Act 8, the controller 1 starts the measurement of an elapsed time since the leading edge of the label paper 201 is detected.

In Act 9, the controller 1 waits until the trailing edge of the label paper 201 is detected by the label sensor 33. Specifically, the controller 1 monitors the level of the detection signal S1 at the label sensor 33. When the level of the detection signal S1 rises to a predetermined threshold or higher, the controller 1 determines that the trailing edge of the label paper 201 is detected by the label sensor 33, that is, Yes. In this case, the controller 1 proceeds to Act 10.

In Act 10, the controller 1 ends the measurement of time.

In Act 11, the controller 1 determines the height of the label paper 201 from the elapsed time measured and the conveying speed of the label paper 201. In this manner, the controller 1 functions as a determination unit for determining the height of the label paper.

In Act 12, the controller 1 checks whether or not the height of the label paper 201 is compatible with the height of the label format selected in Act 1. For example, the controller 1 determines that the height is incompatible when the height of the label paper 201 is out of the predetermined allowable range for each label format, that is, No. As described above, the controller 1 functions as a detection unit for detecting that the size of the label paper 201 in the one direction (e.g., the height direction) is incompatible with the size of the image in the one direction. In this case, the controller proceeds to Act 13.

In Act 13, the controller 1 requests the print engine 3 to stop printing. In response to the request, the print engine 3 temporarily stops the printing operation. In this manner, the controller 1 functions as a stop unit for stopping the printing in response to the detection of incompatibility.

In Act 14, the controller 1 causes the touch panel 4 to display an error screen. The error screen represents a message informing the operator that the label format and the label paper are incompatible with each other. In addition, the error screen includes a button for designating restart of printing and a button for designating the end of printing. A sound emitting device that generates an alarm sound may be provided in the label printer 100 to notify the operator of the error. The controller 1 may control the sound emitting device so as to emit the alarm sound in parallel with the display of the error screen. In this manner, the controller 1 functions as a notification unit for performing a notification operation as a control operation of the touch panel 4 for displaying the error screen.

In Act 15, the controller 1 checks whether or not restart is instructed. When the touch panel 4 detects that the button for designating the restart of printing is touched by the operator, the controller 1 makes a determination of Yes and proceeds to Act 16. In this manner, the controller 1 functions as a restart input unit.

In Act 16, the controller 1 requests the print engine 3 to restart printing stopped at Act 13. In response to this request, the print engine 3 restarts the printing temporarily stopped so as to continue from the stopped state. In this manner, the controller 1 functions as a restart unit. Thereafter, the controller 1 proceeds to Act 17.

In Act 12, the controller 1 determines that the height is compatible with the designated label format when the height of the label paper 201 is within the predetermined allowable range for each label format, that is, Yes. In this case, the controller skips Act 13 to Act 16 and proceeds to Act 17.

In Act 17, the controller 1 waits for completion of the print job being executed. When the printing of the number of labels to be printed set in Act 4 is completed, the controller 1 makes a determination of Yes and proceeds to Act 18. When the touch panel 4 detects that the button for designating the end of printing on the error screen is touched by the operator, the controller 1 makes a determination of No in Act 15, skips Act 16 and Act 17, and proceeds to Act 18. In this manner, the controller 1 functions as an end input unit.

In Act 18, the controller 1 clears the job. That is, the selection and setting in Act 1 to Act 4 are cleared. In this manner, the controller 1 functions as a clearing unit. As a result, the controller 1 ends the information processing illustrated in FIG. 4.

As described above, according to the label printer 100, the size of the label paper 201 being loaded is determined during the printing of the first label and when the size is incompatible with the size of the label format to be printed, the print job is temporarily stopped. Therefore, when the size of the label format to be printed and the label paper 201 being loaded incompatible with each other, although printing is temporarily started, the printing is immediately stopped. Therefore, when the operator mistakes the label paper 201 to be loaded, the operator can notice this fact. Since the label printer 100 displays the error screen on the touch panel 4 at this time, it is possible to ensure that the operator who mistakenly loaded the label paper 201 which is incompatible with the size of the designated label format recognizes this fact. The operator operates so that the label paper is properly reloaded and thereafter the print job is restarted from the beginning, and thus the waste of the label paper can be minimized.

In addition, according to the label printer 100, it is possible to restart the job temporarily stopped as described above in response to an instruction from the operator. Therefore, when the operator intentionally sets the label paper 201 of which size is incompatible with the label format, it is possible to continue the job. In such a case, for example, it is assumed that a blank region where an image is not printed is intentionally formed by using the label paper 201 having a size larger than the size of the label format.

In this embodiment, the following various modifications are possible.

In the above embodiment, it is assumed that the label format is used and the size of the label format is the size of the image to be printed. However, even when the size of the image to be printed is different from the size of the label format by editing the label format, the modification can be performed in substantially the same manner as in the above embodiment. Alternatively, even when printing an image stored in the memory unit 2 or an image acquired from the outside by the interface unit 5 on a label paper without using the label format, the modification can be performed in substantially the same manner as in the above embodiment. However, in these cases, it is checked in Act 12 whether or not the size of the image to be printed and the size of the label paper 201 are compatible with each other.

The label sensor 33 can be replaced with another type of sensor. For example, a sensor that detects the difference in the reflectance of light between the label paper 201 and the mount 202 with a reflection type optical sensor can be applied. In addition, for example, a sensor that reads the mark formed on the mount 202 so as to indicate the position of the end portion of the label paper 201 can be applied.

A portion of the above-described information processing performed by the controller 1 may be omitted. For example, Act 15 and Act 16 may be omitted and Act 14 may proceed to Act 18.

A portion or all of each function realized by the controller by information processing can be realized by hardware which executes information processing not based on a program such as a logic circuit or the like. In addition, each of the above functions can also be realized by combining software control with hardware such as the above logic circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A label printer comprising:
a printing engine configured to print a label image on label papers according to a designated label format as the label papers are conveyed thereto one-by-one;
a sensor configured to detect a presence of the label papers in a conveyance path of the label papers; and
a controller configured to determine a size of a label paper conveyed to the printing engine based on detection signals of the sensor and detect whether or not there is a mismatch of the size with a size of the designated label format.

2. The label printer according to claim 1, further comprising:
a touch screen through which a user designates the label format to be used in printing the label image.

3. The label printer according to claim 2, wherein the controller stops printing of the label image upon detecting the mismatch and controls the touch screen to display an error message.

4. The label printer according to claim 3, wherein
upon detecting the mismatch, the controller controls the touch screen to further display a restart button, and
upon detecting that the restart button has been selected, the controller resumes printing of the label image according to the designated label format on additional label papers.

5. The label printer according to claim 3, wherein
upon detecting the mismatch, the controller controls the touch screen to further display an end of printing button, and
upon detecting that the end of printing button has been selected, the controller terminates printing of the label image according to the designated label format on additional label papers.

6. The label printer according to claim 5, wherein properties of the designated label format are stored in memory upon designation by the user and cleared from the memory when the end of printing button is selected.

7. The label printer according to claim 2, wherein the user designates the label format by selecting one of a plurality of label formats on the touch screen.

8. The label printer according to claim 1, wherein the size is a length of the label paper in a conveyance direction of the label papers.

9. The label printer according to claim 8, wherein the sensor is an optical sensor.

10. The label printer according to claim 9, wherein the optical sensor includes a light emitting unit configured to emit light toward the conveyance path and a light detecting unit on an opposite side of the conveyance path from the light emitting unit.

11. A method of printing labels using a label printer including a printing engine configured to print a label image on label papers according to a designated label format as the label papers are conveyed thereto one-by-one, said method comprising:
conveying a label paper to the printing engine along a conveyance path past a sensor;
printing the label image on the label paper conveyed to the printing engine according to the designated label format;
determining a size of the label paper based on detection signals of the sensor;
detecting whether or not there is a mismatch of the size with a size of the designated label format; and
upon detecting the mismatch, issuing a notification of the mismatch.

12. The method according to claim 11, wherein the sensor is configured to detect a presence of the label paper in the conveyance path.

13. The method according to claim 12, further comprising:
stopping printing of the label image according to the designated label format on additional label papers upon detecting the mismatch.

14. The method according to claim 13, further comprising:
displaying a restart button upon detecting the mismatch; and
resuming printing of the label image according to the designated label format on additional label papers upon detecting that the restart button has been selected.

15. The method according to claim 13, further comprising:
displaying an end of printing button upon detecting the mismatch; and
terminating printing of the label image according to the designated label format on additional label papers upon detecting that the end of printing button has been selected.

16. The method according to claim 15, wherein properties of the designated label format are stored in memory during the printing and cleared from the memory when the end of printing button is selected.

17. The method according to claim 12, wherein a user designates the label format by selecting one of a plurality of label formats.

18. The method according to claim 11, wherein the size is a length of the label paper in a conveyance direction of the label papers.

19. The method according to claim 18, wherein the sensor is an optical sensor.

20. The method according to claim 19, wherein the optical sensor includes a light emitting unit configured to emit light toward the conveyance path and a light detecting unit on an opposite side of the conveyance path from the light emitting unit.
